(19) United States
(12) Patent Application Publication
(10) Pub. No.: US 2021/0179053 A1
(43) Pub. Date: Jun. 17, 2021

(54) ASSEMBLY COMPRISING BRAKE MASTER CYLINDER UNIT AND DASH PANEL

(71) Applicants: TOYOTA JIDOSHA KABUSHIKI KAISHA, Aichi (JP); SUBARU CORPORATION, Tokyo (JP)

(72) Inventors: Yutaka KONDOH, Nagoya-shi (JP); Shuya IWASAKI, Miyoshi-shi (JP); Nao IKUMA, Anjo-shi (JP)

(21) Appl. No.: 17/120,023

(22) Filed: Dec. 11, 2020

(30) Foreign Application Priority Data
Dec. 12, 2019 (JP) 2019-224319

(51) Int. Cl. B60T 13/74; B60T 7/06

(52) U.S. Cl. CPC B60T 13/745; B60Y 2400/42; B60Y 2400/81; B60T 7/065

(57) ABSTRACT

In an assembly comprising a brake master cylinder unit and a dash panel of a vehicle disclosed herein, the electric motor may be fixed to a body of the brake master cylinder unit such that a rotation axis of the electric motor extends along a vehicle-width direction. By fixing the electric motor such that the rotation axis extends along the vehicle-width direction, an overall height of the cylinder unit may be lowered. A position where the pushrod is fixed to the cylinder unit can be lowered, and a position of a pivot of the brake pedal (a connection point between the brake pedal and the dash panel) can also be lowered. As a result, the brake pedal (a pedal arm) can be shortened and weight(s) of part(s) related to the cylinder unit (the pedal arm) can be reduced.

### CROSS-REFERENCE

This application claims priority to Japanese Patent Application No. 2019-224319, filed on Dec. 12, 2019, the entire contents of which are incorporated herein by reference.

### TECHNICAL FIELD

The technique disclosed herein relates to an assembly comprising a dash panel and a brake master cylinder unit connected to the dash panel. Especially, the technique relates to an assembly comprising a brake master cylinder unit that includes an electric motor configured to increase an oil pressure according to a pedaling force on a brake pedal.

### BACKGROUND

A brake master cylinder unit including an electric motor is now often employed as a brake system for an electric vehicle. The electric motor increases an oil pressure according to a pedaling force on a brake pedal. Since such a brake master cylinder unit includes the electric motor, it is heavier than a conventional brake master cylinder unit.

Japanese Patent Application Publication No. 2013-154842 (Patent Literature 1) describes a brake master cylinder unit including an electric motor. A rotation axis of the electric motor described in the Patent Literature 1 extends along a front-rear direction of the vehicle. For clearer explanation, the brake master cylinder unit may hereinafter be simply referred to as a cylinder unit.

### SUMMARY

Since an electric motor is heavy, it would be beneficial to reduce weight(s) of other part(s) related to a cylinder unit.

The present disclosure discloses an assembly comprising a brake master cylinder unit and a dash panel of a vehicle, the brake master cylinder unit being connected to the dash panel. The brake master cylinder unit may comprise an electric motor configured to increase an oil pressure according to a pedaling force on a brake pedal. The brake master cylinder unit may be arranged in front of the dash panel and connected to the brake pedal with a pushrod. In the assembly disclosed herein, the electric motor may be fixed to a body of the brake master cylinder unit such that a rotation axis of the electric motor extends along a vehicle-width direction. By fixing the electric motor such that the rotation axis extends along the vehicle-width direction, an overall height of the cylinder unit may be lowered. A position where the pushrod is fixed to the cylinder unit can be lowered, and a position of a pivot of the brake pedal (a connection point between the brake pedal and the dash panel) can also be lowered. As a result, the brake pedal (a pedal arm) can be shortened and weight(s) of part(s) related to the cylinder unit (the pedal arm) can be reduced. Alternatively, the same effect can be achieved by fixing the electric motor to a lateral side of the body.

Since the overall height of the cylinder unit can be lowered, a space above the cylinder unit in a front compartment of the vehicle may also be effectively used.

In the assembly disclosed herein, the dash panel may comprise a recess in a rear surface of the dash panel and the pushrod extends through a bottom of the recess. By comprising the recess, a position of the cylinder unit may be disposed more toward a front side of the vehicle. As a result, an angle of the pedal arm relative to a horizontal direction at a front side of the pedal body can be reduced. When the angle of the pedal arm at the front side of the pedal body is reduced, an extra space is created in front of a toe of a driver, by which it becomes easier for the driver to press the pedal body.

The details and further improvements of the technique disclosed herein will be described in Detailed Description below.

### BRIEF DESCRIPTION OF DRAWINGS

FIG. 1 shows an exploded perspective view of a plurality of support plates and a plurality of anti-vibration plates employed to an assembly of an embodiment;

FIG. 2 shows a plan view of a cylinder unit as viewed from a vehicle cabin side;

FIG. 3 show a cross-sectional view taken along a line in FIG. 2;

FIG. 4 shows an effect of lowering a height of the cylinder unit; and

FIG. 5 shows an effect of comprising a recess in a dash panel.

### DETAILED DESCRIPTION

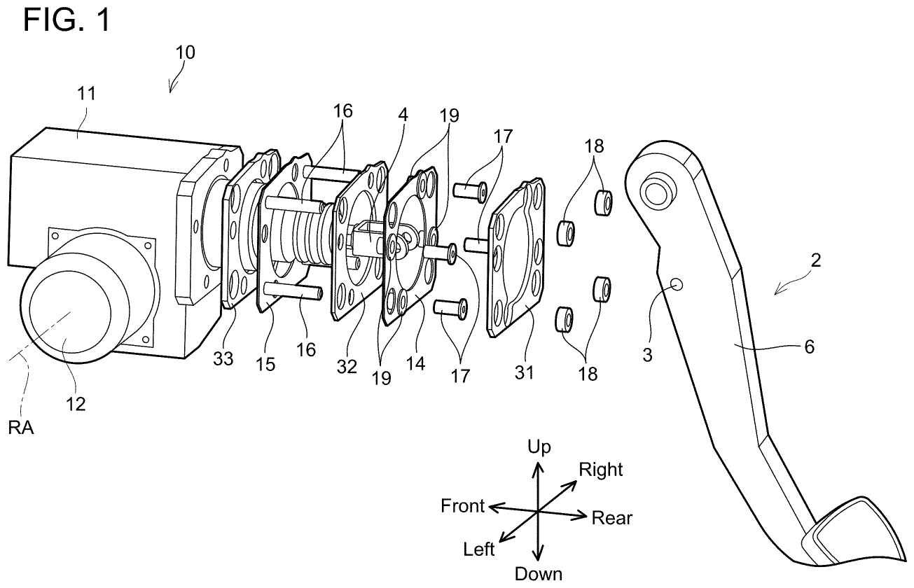

(Embodiment) An assembly 1 of an embodiment will be described with respect to the drawings. The assembly of the embodiment has a structure of connecting a cylinder unit 10 (a brake master cylinder unit 10) to a dash panel. The cylinder unit 10 is connected to the dash panel using a plurality of support plates and a plurality of anti-vibration plates. FIG. 1 shows an exploded view of the plurality of support plates and the plurality of anti-vibration plates. An illustration of the dash panel is omitted in FIG. 1 to facilitate understanding. Further, terms such as “front”, “rear” in a coordinate system of the drawings are based on corresponding directions of the vehicle.

Although not show in FIG. 1, the dash panel is positioned between a first anti-vibration plate 31 (and iron collars 18) and the brake pedal 2. Although details will be described later, a front surface of the dash panel contacts a rear surface of the first anti-vibration plate 31.

The cylinder unit 10 is connected to a pedal arm 6 of the brake pedal 2 via a pushrod 4. A rear end of the pushrod 4 is connected to a connection hole 3 of the pedal arm 6. The pushrod 4 is connected to an oil pressure piston within the cylinder unit 10. When a driver presses the brake pedal, the oil pressure piston is pressed via the pushrod 4, by which an oil pressure within the brake master cylinder unit 10 is increased. Although omitted from the drawing, the cylinder unit 10 is connected to a brake actuator by an oil pressure pipe, and when an oil pressure within a cylinder is increased, the brake actuator operates, by which tires are braked.

The cylinder unit 10 comprises an electric motor 12. Although descriptions of its detailed mechanism are omitted, the electric motor 12 is configured to increase the oil pressure within the cylinder according to a pedaling force on the brake pedal 2. In other words, the oil pressure outputted by the cylinder unit 10 is amplified by the electric motor 12. Due to an amplifying force of the electric motor 12, a great oil (hydraulic) output (i.e., a braking force) is achieved by a small pedaling force. The electric motor 12 is fixed to a body 11 of the cylinder unit 10 such that a rotation axis line RA of the electric motor 12 extends along a vehicle-width direction. The electric motor 12 is fixed to a lateral side of the body 11 (adjacent thereto in a horizontal direction). More specifically, the electric motor 12 is fixed a lower half portion of the lateral side of the body 11.

Meanwhile, the cylinder unit 10 becomes heavier by incorporating the electric motor 12, thus vibration of the cylinder unit 10 affects the dash panel at a greater degree. To address this, the cylinder unit 10 is supported by the dash panel via an anti-vibration plate. By adopting the anti-vibration plate having low rigidity in a plate thickness direction, the vibration of the cylinder unit 10 can be effectively suppressed. However, a problem as follows will occur if one anti- vibration plate is merely interposed between the cylinder unit 10 and the dash. If a part of the anti-vibration plate which supports the cylinder unit 10 has low rigidity, the cylinder unit 10 undesirably moves upon when the driver presses the brake pedal. Such a movement of the cylinder unit 10 changes a resisting force against the pedaling force on the brake pedal. Such a variation in the resisting force may make the driver feel uncomfortable. The assembly 1 described in the embodiment can suppress vibration of the cylinder unit 10 and also ensure high rigidity against the pedaling force on the brake pedal 2.

Description of FIG. 1 will be resumed. The dash panel, which is not shown in FIG. 1, is positioned between the first anti-vibration plate 31 (as well as the iron collars 18) and the brake pedal 2. The first anti-vibration plate 31, a unit-side support plate 14, a second anti-vibration plate 32, a panel-side support plate 15, and a third anti-vibration plate 33 are stacked between the dash panel and the cylinder unit 10 in this order from a rear side to a front side of the vehicle. The unit-side support plate 14 and the panel-side support plate 15 are constituted of metal (iron). The first to the third anti-vibration plates 31 to 33 are constituted of anti- vibration rubber. The first to the third anti-vibration plates 31 to 33 are constituted of, for example, ethylene propylene rubber (Ethylene Propylene Diene Monomer).

Each of the first to the third anti-vibration plates 31 to 33, the unit-side support plate 14, and the panel-side support plate 15 has a large hole at a center, and the pushrod 4 extends through these holes. Each of the first to the third anti-vibration plates 31 to 33, the unit-side support plate 14, and the panel-side support plate 15 has a plurality of small holes around the central large hole. Hexagonal low-head bolts 17, stud bolts 16, and/or the like are inserted through these small holes. The hexagonal low-head bolts 17 are accompanied with iron collars 19, and the stud bolts 16 are accompanied with the iron collars 18. A relation among the hexagonal low-head bolts 17, the iron collars 19, the stud bolts 16, and the iron collars 18 will be mentioned later.

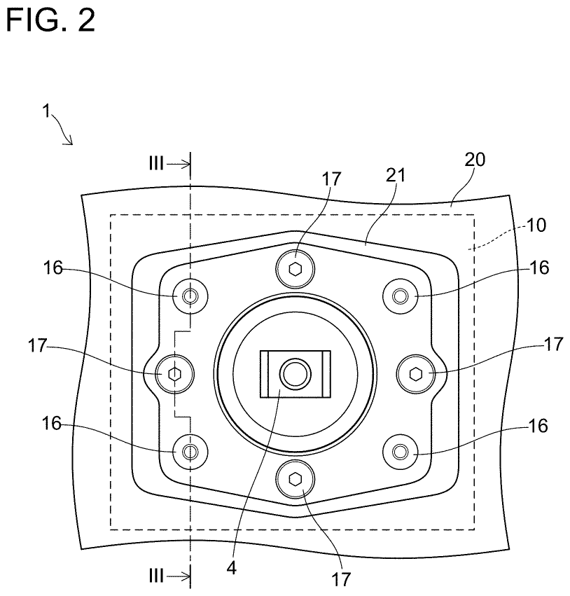

FIG. 2 shows a dash panel 20 as viewed from a vehicle cabin side. FIG. 2 does not show the brake pedal. A spacer 21 is positioned in front of the dash panel 20 along a viewing direction of FIG. 2, and the cylinder unit 10 is fixed to the dash panel 20 via the spacer 21 and/or the like. The aforementioned panel-side support plate 15 (see FIG. 1) is fixed to the dash panel 20 with the four stud bolts 16, and the unit-side support plate 14 (see FIG. 1) is fixed to the cylinder unit 10 with the four hexagonal low-head bolts 17. The pushrod 4 is surrounded by a bellows tube on a cylinder unit 10 side, however, the bellows tube is not shown in FIG. 2 (and in the following drawings).

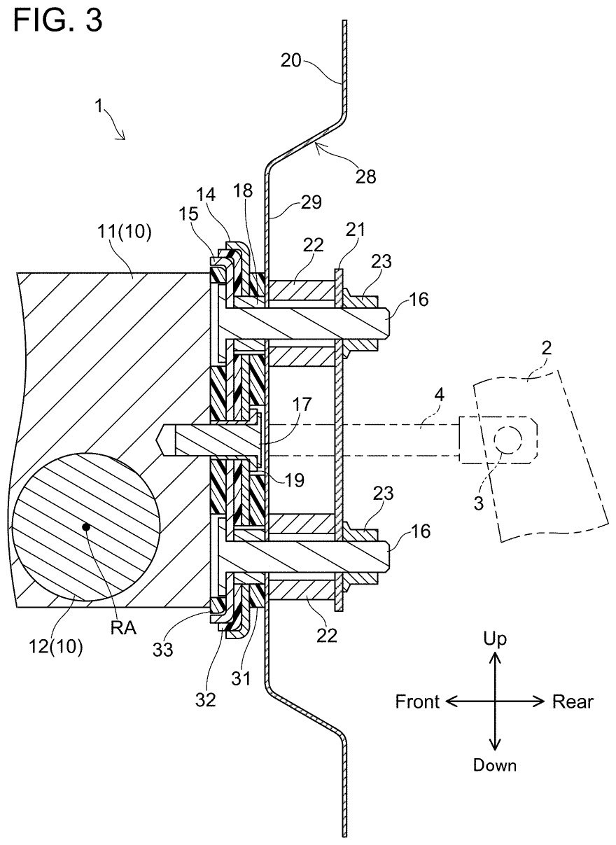

FIG. 3 shows a cross-sectional view taken along a line in FIG. 2. FIG. 3 shows a cross section that crosses the stud bolts 16 and one of the hexagonal low-head bolts 17. FIG. 3 depicts the brake pedal 2, the pushrod 4, and the electric motor 12 by phantom lines. FIG. 3 illustrates the dash panel 20 in a broader area than in FIG. 2.

As mentioned before, the first anti-vibration plate 31, the unit-side support plate 14, the second anti-vibration plate 32, the panel-side support plate 15, and the third anti-vibration plate 33 are stacked in this order between the dash panel 20 and the cylinder unit 10 from the rear side to the front side of the vehicle. The stud bolts 16 are welded to the panel-side support plate 15. The panel-side support plate 15 is fixed to the dash panel 20 with the stud bolts 16. The panel-side support plate 15 is positioned parallel to the dash panel 20 between the dash panel 20 and the cylinder unit 10. The stud bolts 16 are inserted through the iron collars 18, and are fixed to the dash panel 20. Behind the dash panel 20, the stud bolts 16 are passed through other iron collars 22. The stud bolts 16 are fixed to the dash panel 20 via the spacer 21 with nuts 23. In other words, the panel-side support plate 15, the iron collars 18, 22, the dash panel 20, and the spacer 21 are clamped from opposing sides with the stud bolts 16 and the nuts 23. All of the panel-side support plate 15, the iron collars 18, 22, the dash panel 20, and the spacer 21 are constituted of metal (iron). In particular, each of the iron collars 18 has one end being in contact with the dash panel 20, and the other end being in contact with the panel-side support plate 15. Although the first anti-vibration plate 31, the unit-side support plate 14, and the second anti-vibration plate 32 are also interposed between the panel-side support plate 15 and the dash panel 20, a load received by the panel-side support plate 15 is transferred directly to the dash panel 20 through the iron collars 18.

The unit-side support plate 14 is fixed to the cylinder unit 10 with the hexagonal low- head bolts 17. The unit-side support plate 14 is positioned parallel to the dash panel 20 between the panel-side support plate 15 and the dash panel 20. The iron collars 19 are interposed between the cylinder unit 10 and the unit-side support plate 14. Each of the iron collars 19 has one end being in contact with the unit-side support plate 14 and the other end being in contact with the cylinder unit 10. Although the second anti-vibration plate 32, the panel-side support plate 15, and the third anti-vibration plate 33 are also interposed between the cylinder unit 10 and the unit-side support plate 14, a load received by the unit-side support plate 14 is transferred directly to the cylinder unit 10 through the iron collars 19.

As shown in FIG. 3, a rear surface of the dash panel 20 comprises a recess 28. A part of a front surface of the dash panel 20 corresponding to the recess 28 protrudes to the front side of the vehicle. The pushrod 4 extends through a bottom 29 of the recess 28 and connects the brake pedal 2 and the cylinder unit 10 to each other. The cylinder unit 10 is disposed on the front side of the vehicle with respect to the recess 28.

An advantage of the assembly 1 of the embodiment will be described. The electric motor 12 is fixed such that the rotation axis line RA extends along the vehicle-width direction. The electric motor 12 is fixed to the lateral side of the body 11 in the vehicle-width direction (adjacent thereto in the horizontal direction) rather than to an upper or a lower side of the body 11. With this structure, an overall height of the cylinder unit 10 can be lowered. As a result, the cylinder unit 10 can be disposed in a position lower than a conventional configuration.

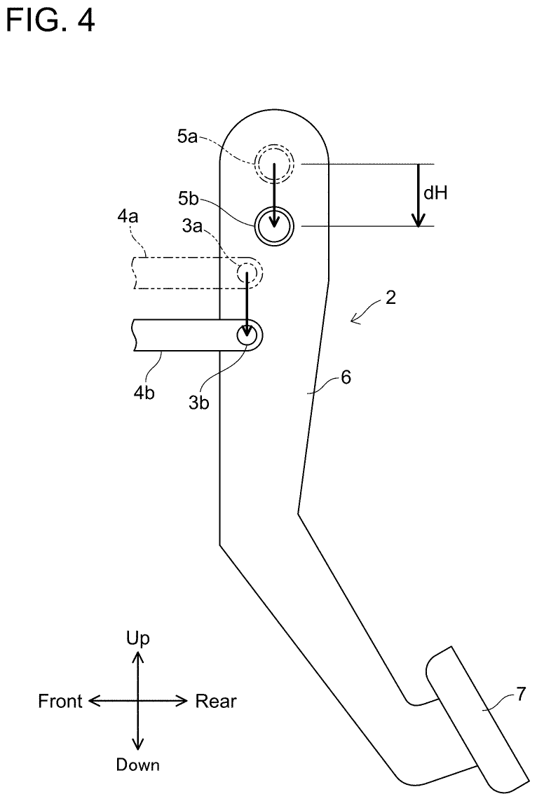

When a position at which the cylinder unit 10 is disposed is lowered, a position of the pushrod 4 can also be lowered, by which a position of the connection hole 3 of the brake pedal 2 to be connected to the pushrod 4 can also be lowered. FIG. 4 shows a side view of the brake pedal 2. Reference signs 4a, 3a indicate the pushrod 4 and the connection hole 3 in their conventional positions, respectively. Reference signs 4b, 3b indicate the respective positions of the pushrod 4 and the connection hole 3 realized by lowering the height of the cylinder unit 10.

The brake pedal 2 is connected to the dash panel 20 by a pivot 5 (5a, 5b). A reference sign 5a indicates a position of the pivot 5 of a conventional brake pedal. A stroke of the pushrod 4 when the brake pedal 2 is pressed may be the same in a conventional case and in the present embodiment. When the position of the connection hole 3 is changed from a position 3a to a position 3b, the position of the pivot 5 of the brake pedal 2 may also be changed from a position 5a to a position 5b. A position of the pedal body 7 may be the same as the conventional configuration. When the position of the pivot 5 is lowered from the position 5a to the position 5b by a length dH while the position of the pedal body 7 is kept unchanged, the pedal arm 6 can be shortened by the length dH. Since a length of the brake pedal 2 (the pedal arm 6) can be shortened, weight of the brake pedal 2 (the pedal arm 6) can be reduced.

The brake pedal 2 (the pedal arm 6) is a part related to the cylinder unit 10. The cylinder unit 10 is heavier by incorporating the electric motor 12. On the other hand, the electric motor 12 is fixed to the body 11 of the cylinder unit 10 such that the rotation axis line RA extends along the vehicle-width direction, by which the weight of the brake pedal 2 (the pedal arm 6) can be reduced. Due to the brake pedal 2 (the pedal arm 6) being lighter in weight, an increase in weight of the electric motor 12 can be offset to some extent.

The cylinder unit 10 is arranged in front of the recess 28 of the dash panel 20. By the dash panel 20 comprising the recess 28, the cylinder unit 10 can be disposed more toward the front side of the vehicle. By disposing the cylinder unit 10 more toward the front side of the vehicle, the connection hole 3 of the brake pedal 2 (the pedal arm 6) to be connected to the pushrod 4 can also be disposed more toward the front side of the vehicle.

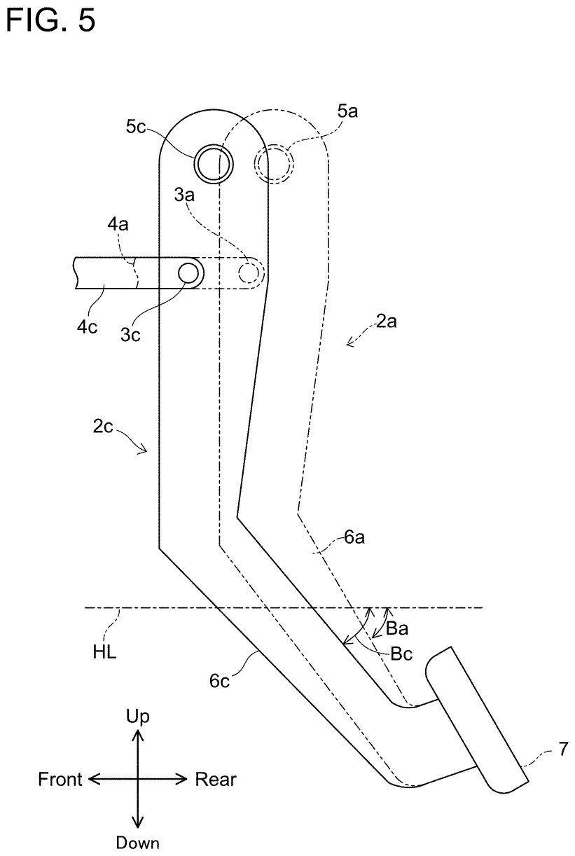

FIG. 5 shows the side view of the brake pedal 2. Reference signs 2a (6a), 3a, 4a, 5a indicate the brake pedal 2 (the pedal arm 6), the connection hole 3, the pushrod 4, and the pivot 5 in their conventional positions, respectively. Reference signs 2c (6c), 3c, 4c, 5c indicate positions of the brake pedal 2 (the pedal arm 6), the connection hole 3, the pushrod 4, and the pivot 5 that are realized by disposing the cylinder unit 10 more toward the front side of the vehicle, respectively. The shape of the pedal arm 6 is slightly changed.

By changing arrangement of the pivot 5 from the position 5a to the position 5c and changing arrangement of the connection hole 3 from the position 3a to the position 3c, the pedal arm 6 can be rotated toward the front side of the vehicle. Contrary to this, the position of the pedal body 7 may be the same as the conventional configuration. As a result, an angle of the pedal arm 6 relative to the horizontal direction (a one-dot chain line HL in the drawing) can be changed from an angle Ba to an angle Bc on the front side of the pedal body 7. The angle Bc is smaller than the angle Ba. In other words, by the dash panel 20 comprising the recess 28, the angle of the pedal arm 6 relative to the horizontal direction on the front side of the pedal body 7 of the brake can be reduced. When the angle of the pedal arm on the front side of the pedal body is reduced, an extra space is created in front of a toe of a driver, by which it becomes easier for the driver to press the pedal body 7.

Specific examples of the present disclosure have been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. An assembly comprising a brake master cylinder unit and a dash panel of a vehicle, the brake master cylinder unit being connected to the dash panel, wherein
the brake master cylinder unit comprises an electric motor configured to increase an oil pressure according to a pedaling force on a brake pedal, and the brake master cylinder unit is arranged in front of the dash panel and connected to the brake pedal with a pushrod, and
the electric motor is fixed to a body of the brake master cylinder unit such that a rotation axis of the electric motor extends along a vehicle-width direction.

2. The assembly of claim 1, wherein the dash panel comprises a recess in a rear surface of the dash panel and the pushrod extends through a bottom of the recess.

3. An assembly comprising a brake master cylinder unit and a dash panel of a vehicle, the brake master cylinder unit being connected to the dash panel, wherein
the brake master cylinder unit comprises an electric motor configured to increase an oil pressure according to a pedaling force on a brake pedal, and the brake master cylinder unit is arranged in front of the dash panel and connected to the brake pedal with a pushrod, and
the electric motor is fixed to a lateral side of a body of the brake master cylinder unit.

4. The assembly of claim 3, wherein the dash panel comprises a recess in a rear surface of the dash panel and the pushrod extends through a bottom of the recess.
